(19) United States
(12) Patent Application Publication
(10) Pub. No.: US 2009/0241345 A1
(43) Pub. Date: Oct. 1, 2009

(54) Utility knife with a pivotal actuator served as an auxiliary handgrip

(76) Inventor: Yin Han Huang, Taichung (TW)

Correspondence Address: SAM CHEN, 7F-1, 293, ROOSEVELT ROAD, SEC 3, TAIPEI, TW

(21) Appl. No.: 12/055,322

(22) Filed: Mar. 26, 2008

(51) Int. Cl. B26B 1/08

(52) U.S. Cl. 30/123; 30/162

(57) ABSTRACT

A utility knife includes a handle and an actuator pivotably secured to the rear end of the handle and served as an auxiliary handgrip. In a storage position the actuator is fastened at the bottom of the handle. The actuator is adapted to dispose about perpendicular to the handle by pivoting such that subsequently moving the actuator axially through an axial slot of the handle will extend front portions of a blade and a blade carrier out of the handle. In this position, a user can exert a greater force in cutting an object by grasping both the handle and the handgrip.

### BACKGROUND OF THE INVENTION

1. Field of Invention

The invention relates to utility knives and more particularly to a utility knife having a pivotal actuator served as an auxiliary handgrip so that a user can exert a greater force during use by grasping both the short handle and the auxiliary handgrip.

2. Description of Related Art

Utility knife is a common tool used in various trades and crafts for a variety of purposes. One conventional type the handle has a short handle for the consideration of portability. However, it suffers from a couple of disadvantages. For example, a user may have difficulty of exerting a sufficient force during use due to the short handle. Further, the hand tends to be hurt when the user tries to exert a great force on the handle if sufficient care is not taken. Thus, the need for improvement still exists.

There have been numerous suggestions in prior patents for utility knife. For example, U.S. Pat. No. 7,316,070 discloses a self-retracting utility knife.

### SUMMARY OF THE INVENTION

It is therefore one object of the invention to provide a utility knife having a pivotal actuator served as an auxiliary handgrip so that a user can exert a greater force during use by grasping both the handle and the auxiliary handgrip.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of utility knife according to the invention;

FIG. 2 is an exploded view of the utility knife;

FIG. 3 is a side elevation of the utility knife showing the actuator being disposed about perpendicular to the handle by pivoting with the blade retracted into the handle in an inoperative position;

FIG. 4 is a view similar to FIG. 3 showing the actuator being actuated to push the blade to an extended position; and

FIG. 5 is an exploded perspective view of the front portion of the utility knife showing a blade replacement operation.

### DETAILED DESCRIPTION OF THE INVENTION

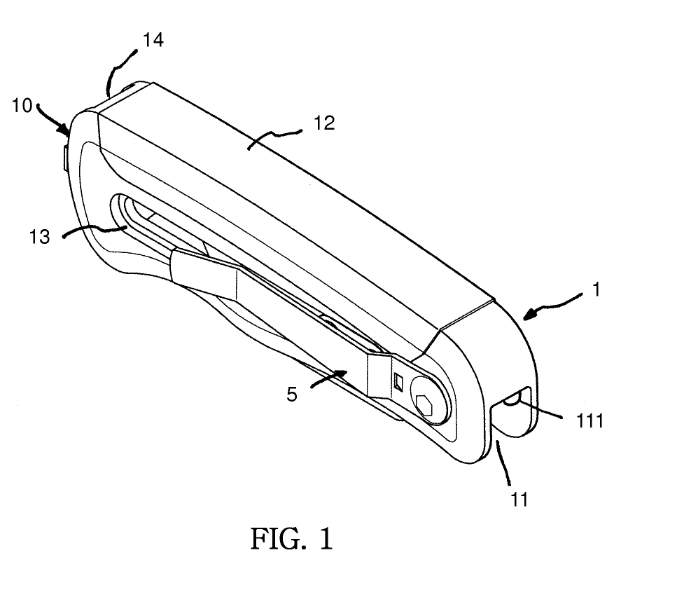

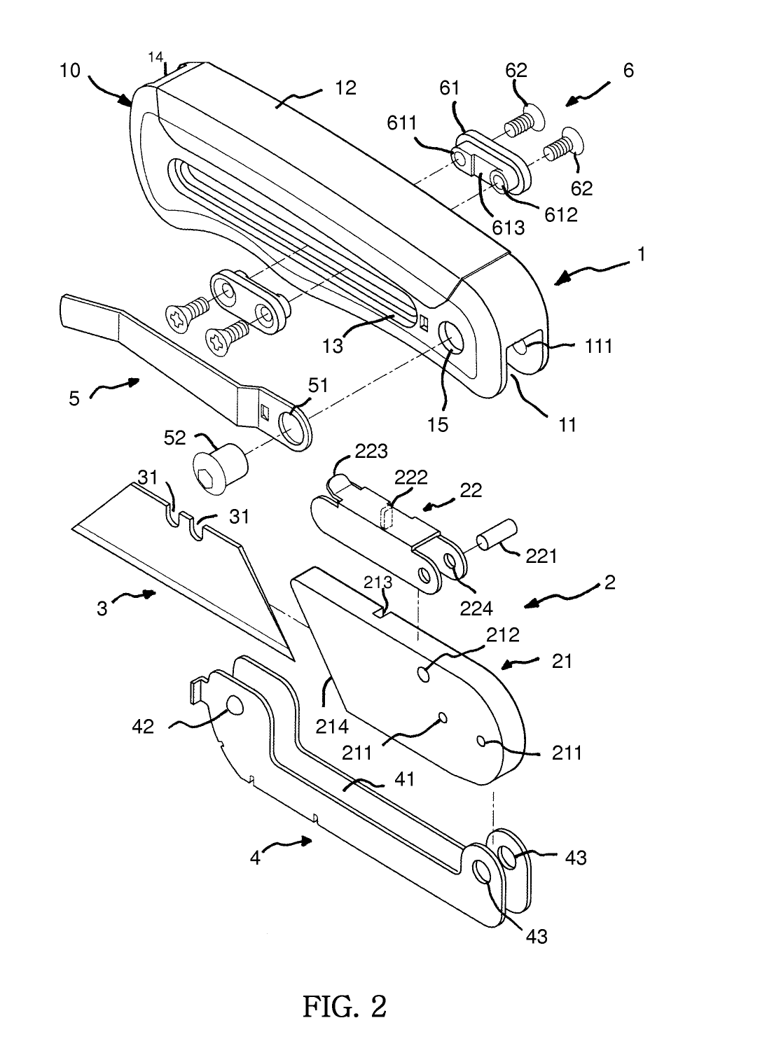

Referring to FIGS. 1 to 5, a utility knife in accordance with a preferred embodiment of the invention comprises a handle 1, a blade 3, a blade carrier 2, two slidable fastening mechanisms 6, and an actuator 4. Each component is discussed in detail below.

The handle 1 comprises a housing 10 of substantially inverted-U section and a slip-resistant member 12 of substantially inverted-U section fixedly secured onto a top surface of the housing 10. The housing 10 includes an axially elongated slot 11, two rear opposite protrusions 111 of substantially semi-spherical on two opposite walls of the slot 11, two elongated side openings 13 in communication with the slot 11, a front blade opening 14, and an aperture 15 on one side between the side opening 13 and the protrusion 111 of the same side.

The blade carrier 2 comprises a hollow blade support 21 including a front slanting opening 214, two lengthwise threaded holes 211 on either side, a through hole 212 proximate the top, and a groove 213 on the other side terminating on the top; and a seat 22 of substantially inverted-U section including two rear holes 224 on both sides, a pin 221 inserted through the holes 224 and the through holes 212 to pivotably secure the seat 22 to the blade support 21, a rectangular projection 222 inserted into both the groove 213 and either notch 31 on the back edge of the trapezoidal blade 3 to lockingly secure the blade support 21 and the blade 3 together, and a front top bend 223.

The fastening mechanism 6 comprises an elongated plate 61 having two spaced mounting bosses 611, two threaded holes 612 through the mounting bosses 611, and an inner flat riser 613 between the mounting bosses 611, and two fasteners (e.g., screws) 62.

The actuator 4 of U section comprises an axial slot 41, a front upper protuberance 42 on either side, and a rear upper pivot hole 43 on either side, the pivot holes 43 being put on the mounting bosses 611 to partially engage the rear ends of the actuator 4 with the riser 613. Also, the fasteners 62 are driven through the threaded holes 612 and the mounting bosses 611 into the threaded holes 211 to secure the fastening mechanisms 6 and the blade support 21 together.

The utility knife further comprises a clip member 5 including a rear hole 51 and a pin 52 driven through the hole 51 into the aperture 15 to fixedly secure the clip member 5 to one side of the housing 10. The provision of the clip member 5 allows a user to secure the utility knife to cloth pocket or belt while carrying same.

In a storage state the blade carrier 2 is fitted in the slot 11 of the housing 10 and seated on the slot 41 of the actuator 4 which is retracted into the slot 11 of the housing 10. The blade 3 is retracted into the handle 1. Also, the front protuberances 42 are urged against the inner walls of the housing 10 and the rear ends of the actuator 4 are urged by the rear protrusions 111. As a result, the actuator 4 is fastened in the housing 10.

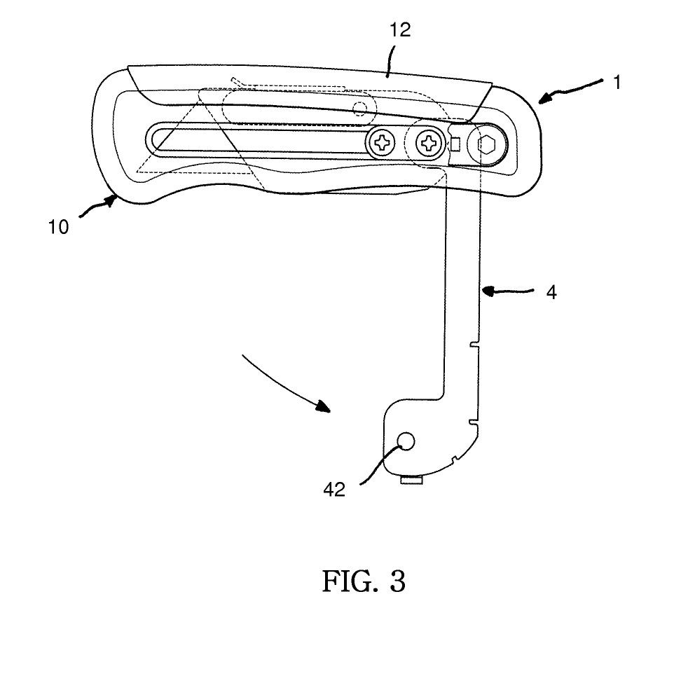

In use a user may pivotably pull down the actuator 4 (i.e., pivot about the pivot holes 43) until the rear ends of the actuator 4 are stopped by an internal member (not shown) of the housing 10 (see FIG. 3). At this time, the actuator 4 is disposed about perpendicular to the housing 10.

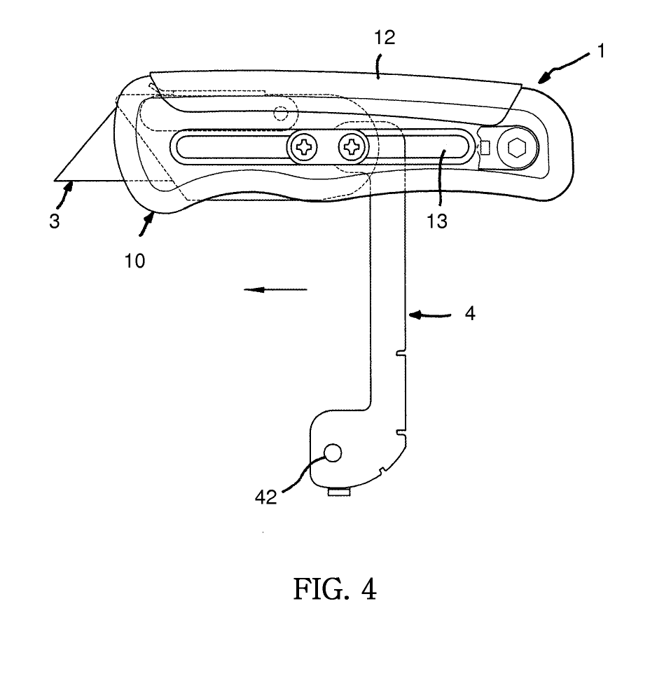

As shown in FIG. 4, next the user may grasp and move the actuator 4 axially through the slot 11 (i.e., moving the blade carrier 2 too). As a result, the blade 3 is extended through the blade opening 14 to be ready for cutting. It is contemplated by the invention that after fully extending the blade 3 the user may grasp both the handle 1 and the actuator 4 to cut an object in a labor saving manner. While the handle 1 is short, the desired cutting work is not adversely affected because the actuator 4 can provide an increased grasping force to the hand.

It is understood that the procedure described with respect to FIGS. 3 to 4 can be traversed in the opposite direction to retract the blade 3 into the handle 1 and thus dispose the utility knife in a storage position.

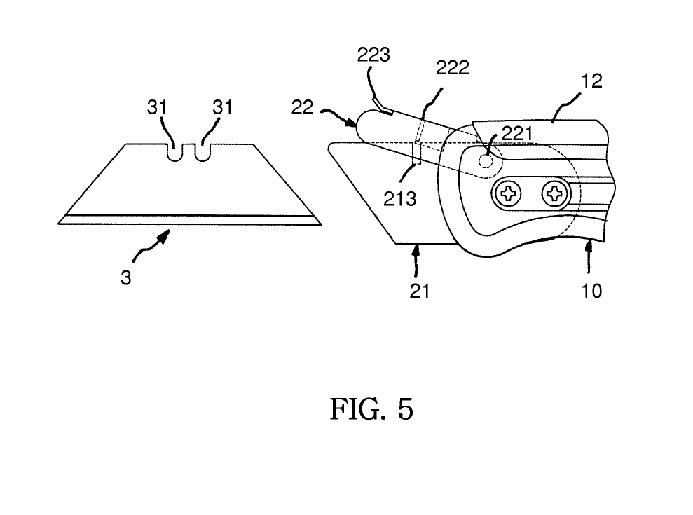

As shown in FIG. 5, a blade replacement operation is described. Front portions of both the seat 22 and the blade support 21 are exposed after fully extending the blade 3. Thus, the user may lift the bend 223 of the seat 22 by pivoting about the pin 221 until the bend 223 is stopped. At this position, the projection 222 clears both the groove 213 and the notch 31. As a result, the blade 3 is unfastened. Therefore, the user may remove the worn or damaged blade 3 from the blade support 21 and then install a new blade 3 as replacement.

It is also understood that a small portion of the cutting edge of the blade 3 can be exposed for cutting when the projection 222 inserts into the front notch 31 and a large portion of the cutting edge of the blade 3 can be exposed for cutting when the projection 222 inserts into the rear notch 31.

While the invention herein disclosed has been described by means of specific embodiments, numerous modifications and variations could be made thereto by those skilled in the art without departing from the scope and spirit of the invention set forth in the claims.

What is claimed is:

1. A utility knife comprising:
a housing (10) of substantially inverted-U section comprising an axially elongated slot (11), two rear opposite protrusions (111 ) on two opposite walls of the slot (11), two elongated side openings (13) in communication with the slot (11), and a front blade opening (14);
a blade carrier (2) comprising a blade support (21) for supporting a blade (3), the blade support (21) including a groove (213) on the other side terminating on the top, and a seat (22) of substantially inverted-U section pivotably secured onto the blade support (21) and including a projection (222) inserted into the groove (213) and one of at least one notch (31) on the back edge of the blade (3) for securing the blade support (21) and the blade (3) together;
an actuator (4) of substantially U section adapted to receive a lower portion of the blade support (21) and comprising a front protuberance (42) on either side; and
two fastening mechanisms (6) slidably disposed in the side openings (13) and pivotably secured the rear end of the actuator (4) to the rear end of the blade support (21);
wherein in a retracted position of the blade (3) a portion thereof projects out of the blade support (21), the blade carrier (2) is received in the housing (10), the protuberances (42) are urged against the housing (10), the rear end of the actuator (4) is urged by the protrusions (111), and the fastening mechanisms (6) are disposed at the rear ends of the side openings (13); and
wherein the actuator (4) is adapted to pivot to be disposed about perpendicular to the housing (10) such that moving the actuator (4) axially through the slot (11) will extend front portions of the blade (3) and the blade carrier (2) out of the blade opening (14) until the fastening mechanisms (6) are stopped at the front ends of the side openings (13).

2. The utility knife of claim 1, further comprising a clip member (5) secured to one side of the housing (10).

3. The utility knife of claim 1, further comprising a slip-resistant member (12) fixedly secured onto the housing (10).

4. The utility knife of claim 1, wherein the seat (22) further comprises a front top bend (223).
